(19) United States
(12) Patent Application Publication
(10) Pub. No.: US 2007/0062354 A1
(43) Pub. Date: Mar. 22, 2007

(54) WORK PIECE SUPPORT STRUCTURE

(76) Inventors: Glen LANGDON, Templestowe (AU); Darren REUKERS, Templestowe (AU)

Correspondence Address: STITES & HARBISON PLLC, 1199 NORTH FAIRFAX STREET, SUITE 900, ALEXANDRIA, VA, 22314, US

(21) Appl. No.: 11/533,552

(22) Filed: Sep. 20, 2006

(30) Foreign Application Priority Data
Sep. 22, 2005 (AU) 2005100785

(51) Int. Cl. B26D 7/02

(52) U.S. Cl. 83/451

(57) ABSTRACT

A work piece support structure for waterjet cutting apparatus comprising a cutting table having a plurality of space to part slats, the table being supported in a cantilever fashion by a bar adapted to be positioned at the top of the front of the water tank of the waterjet cutting apparatus, the bar being axially rotatable relative to the tank and means to cause rotation of the bar from a first position in which the slats extend across the top of the tank to support the work piece for cutting and a second inclined position in which the slats extend upwardly to support the work piece during loading or unloading of the work piece.

### INTRODUCTION

This invention relates to a work piece support structure for waterjet cutting apparatus and in particular waterjet cutting with abrasives.

### BACKGROUND OF THE INVENTION

Waterjet cutting has been used for some years to cut a variety of materials such as steel, aluminium, glass, marble, plastics, rubber, cork and wood. The work piece is placed on a cutting table over a bath of water and a cutting head is accurately displaced across the work piece to complete the desired cut. The cutting action is carried out by the combination of a very high pressure jet (up to 55,000 psi) of water entrained with fine particles of abrasive material, usually sand, that causes the cutting action. The water and sand that exits the cutting head is collected beneath the work piece in a tank. The work piece is usually supported on a cutting table located in the top of the water bath. The table usually comprises a series of parallel steel slats or beams that provide spaced support for the underside of the work piece whilst defining many spaces for passage of the water and abrasive.

This cutting technique is very powerful and can cut through stainless steel as thick as 100 mm or 4 inches. The cutting process can also be extremely accurate with tolerances of plus or minus 0.1 mm or 0.004 inches. The process is clean, fast and reliable.

The waterjet cutting process described above has proved especially useful for the cutting of fragile materials such as glass and stone. However, there is a problem in placing the work piece onto the table in the bath of water prior to the cutting action. Great care has to be taken to position fragile material such as glass and/or stone on the cutting table.

One commonly used technique is a overhead jig with a vacuum head that, through suction, attaches itself to the work piece which can then be positioned over the cutting table and lowered onto the table. The overhead jig can also include means to rotate the work piece and/or move it incrementally of the bath.

However, there are certain large work pieces such as glass and stone in which additional care has to be taken in respect of the loading and unloading of the work piece and the use of a vacuum activated contact does not provide the necessary degree of support. The use of a vacuum head can also cause scratching of the glass due to pressure of the abrasive.

It is these issues that have brought about the present invention.

### SUMMARY OF THE INVENTION

According to the present invention there is provided a work piece support structure for waterjet cutting apparatus comprising a cutting table having a plurality of spaced apart slats, the table being supported in a cantilever fashion by a bar adapted to be positioned at the top of the front of a water tank of the waterjet cutting apparatus, the bar being axially rotatable relative to the tank and means to cause rotation of the bar from a first position in which the slats extend across the top of the tank to support the work piece for cutting and a second inclined position in which the slats extend upwardly to support the work piece during loading or unloading of the work piece.

Preferably the slats are supported on the bar by elbow shaped links that are displaceable along the bar to vary the spacing of the slats.

The bar is preferably mounted in spaced apart bearing secured to the front of the tank.

The means to displace the bar is preferably a hydraulic or pneumatic ram.

In one embodiment the table comprises an open framework supported by side arms that are connected to the bar. The table is preferably secured to the side arms to be displaceable longitudinally of the arms from a lower position at which the work piece can be lifted onto or off the table to an operative position where the work piece is over the tank to facilitate the cutting operation.

At least one hydraulic ram is preferably used to displace the framework relative to the side arms.

### DESCRIPTION OF THE DRAWINGS

Embodiments of the present invention will now be described by way of example only with reference to the accompanying drawings in which:

FIG. 1 is a plan view of a cutting bath of waterjet cutting apparatus illustrating a work piece support table in accordance with a first embodiment;

FIG. 2 is an end elevational view of the cutting bath showing the support table in an inclined position;

FIG. 3 is a side elevational view of the bath showing the support table in an inclined position;

FIG. 4 is a side elevational view of the bath with the support table in the lowered position;

FIG. 5 is a side elevational view of the bath illustrating an alternative form of work piece support table in the inclined position;

FIG. 6 is a plan view of a 500 kg cutting table with lifting mechanism;

FIG. 7 is an end elevational view of the cutting table;

FIG. 7A is an enlarged view of the components within the rectangle A of FIG. 7;

FIG. 7B is a side view of FIG. 7A.

FIG. 8 is a side elevational view of the table with the cutting table in the lowered position;

FIG. 9 is a side elevational view of the cutting table in a inclined position; and

FIG. 10 is a side elevational view of the cutting table in an inclined position with the work piece lowered.

### DESCRIPTION OF THE PREFERRED EMBODIMENTS

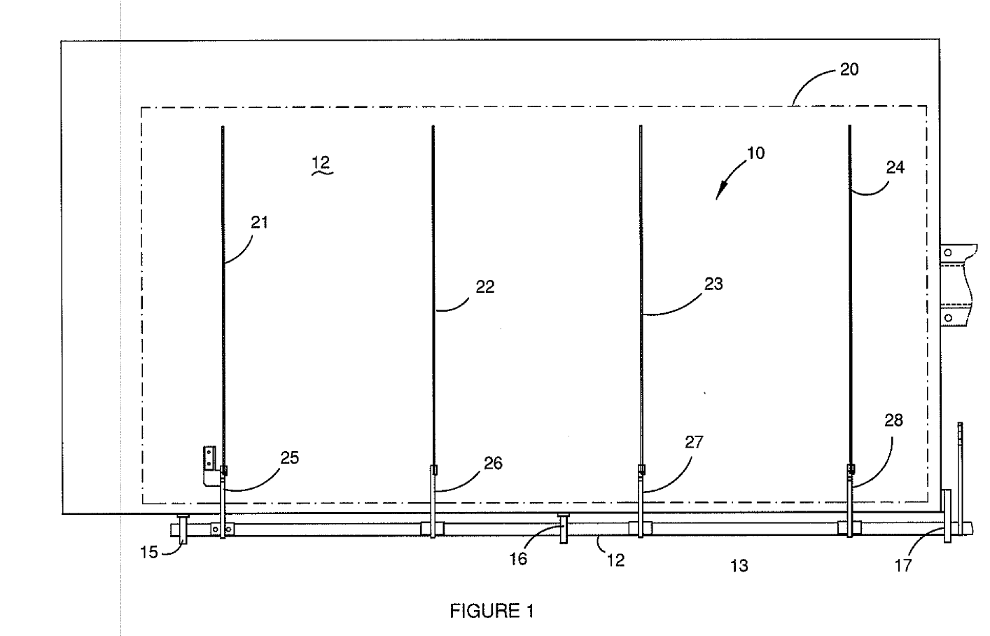

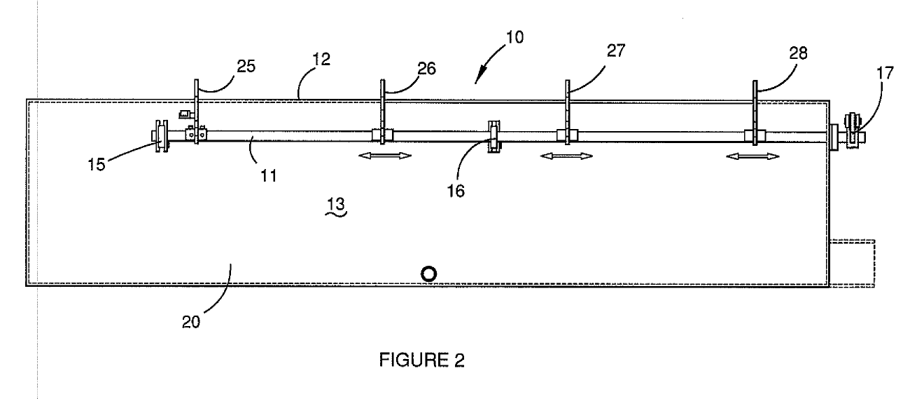

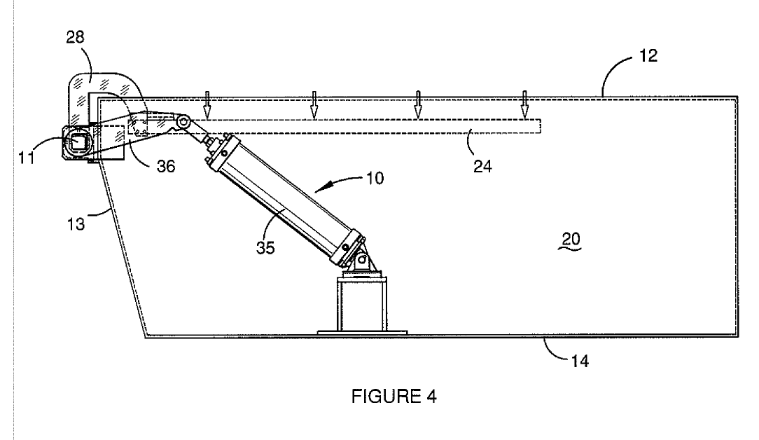

In the embodiment shown in FIGS. 1 to 4, cutting table 10 is designed to accommodate a work piece of up to 120 kg. The cutting table 10 is positioned against the top 12 of a substantially rectangular cutting tank 20 that, in use, contains water. The cutting table 10 comprises an elongate bar 11 of square cross section that is mounted along the top 12 of the front 13 of the cutting tank 20 and supported thereon via bearings 15, 16, 17 at three spaced positions shown in FIG. 2. The bar 11 has cylindrical portions that are supported by the bearings to facilitate the capacity for the arm to axially rotate. The bar 11 is designed to support four replaceable elongate slats 21, 22, 23, 24 that are supported by elbow shaped holders 25, 26, 27, 28 to be displaceable along the length of the bar 11. As shown in FIG. 2, the left hand holder 25 is fixed to the bar 11 but the other three elbow shaped holders 26, 27, 28 are designed to be displaceable along the length of the bar to vary the spacing of the slats. The slats 21-24 extend outwardly of the bar across the tank as shown in FIGS. 1 and 4 in a cantilever fashion. As shown in FIG. 4, when in the operative position, the slats 21-24 extend just above the water level at the top of the tank 20 and support the work piece which is usually a flat sheet of glass or stone. The slats can have soft blocks (not shown) of rubber on which the work piece rests.

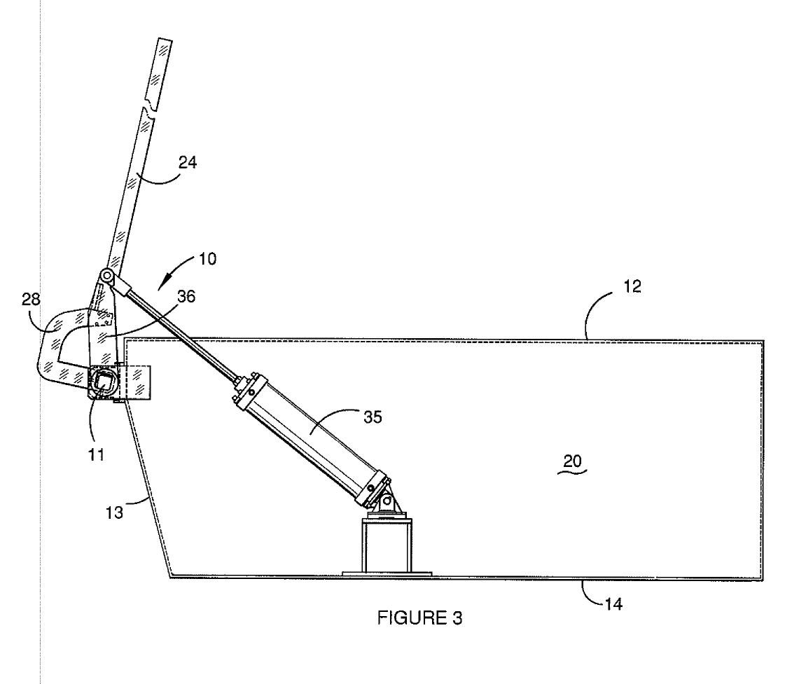

In this embodiment, the cutting table 10 is designed to be displaceable from an operative position shown in FIG. 4 in which the slats 21, 22, 23, 24 extend horizontally across the tank to an inclined position shown in FIG. 3 in which the slats 21, 22, 23, 24 extend upwardly out of the tank. A pneumatic ram 35 is bolted to the base 14 of the tank 20 to extend upwardly at an angle of about 45° to be in turn coupled to a lever 36 that is coupled to the bar 11 so that actuation of the pneumatic ram 35 from the position of FIG. 4 to the position of FIG. 3 forces the lever 36 upwardly so that the slats 21, 22, 23, 24 assume the inclined position shown in FIG. 3. In this position, the glass or stone can be carefully positioned against the slats 21, 22, 23, 24, either for loading or unloading of the apparatus.

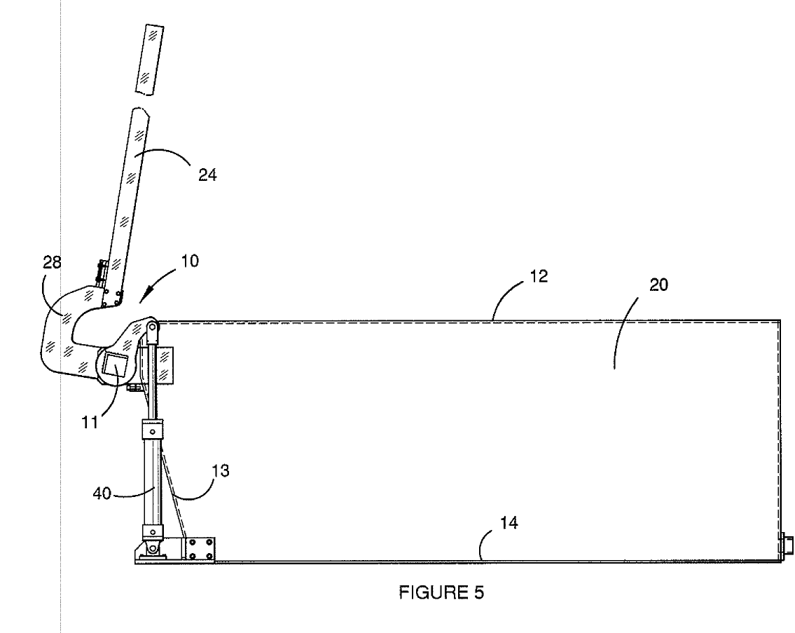

The embodiment shown in FIG. 5 is very similar to the embodiment of FIGS. 1 to 4 except that it has been designed to take a greater load, namely 300 kg. In this case the pneumatic cylinder has been replaced by a hydraulic ram 40 that is mounted against the base of the forward edge of the tank 20. The hydraulic ram operates in a substantially vertical plane and is not inclined at 45° as the pneumatic ram of the first embodiment.

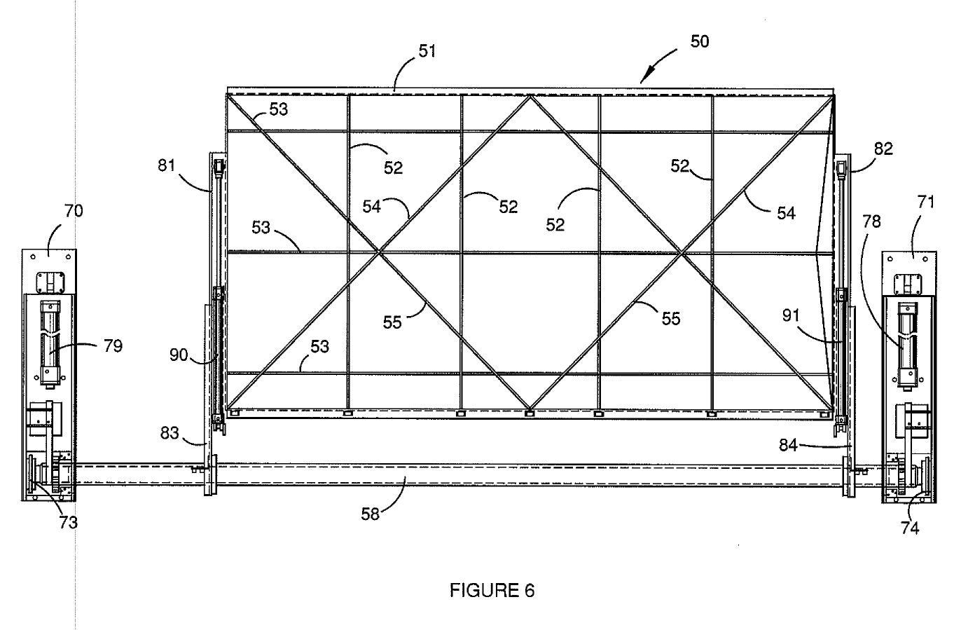

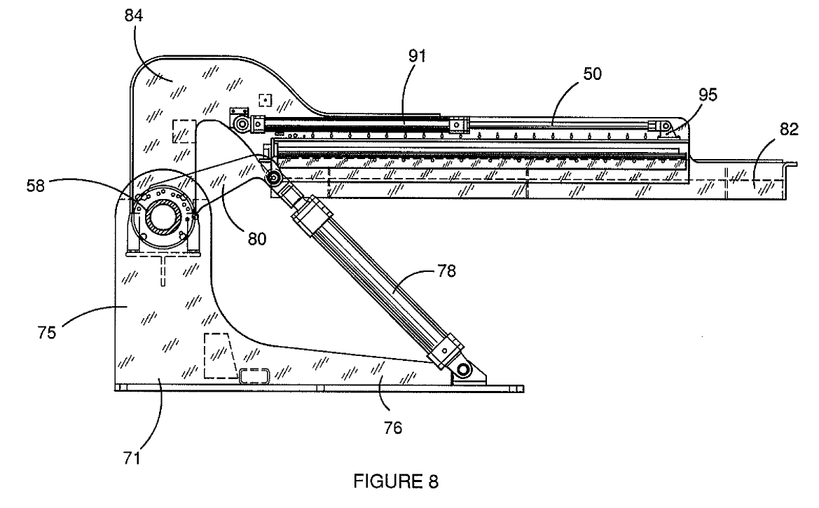

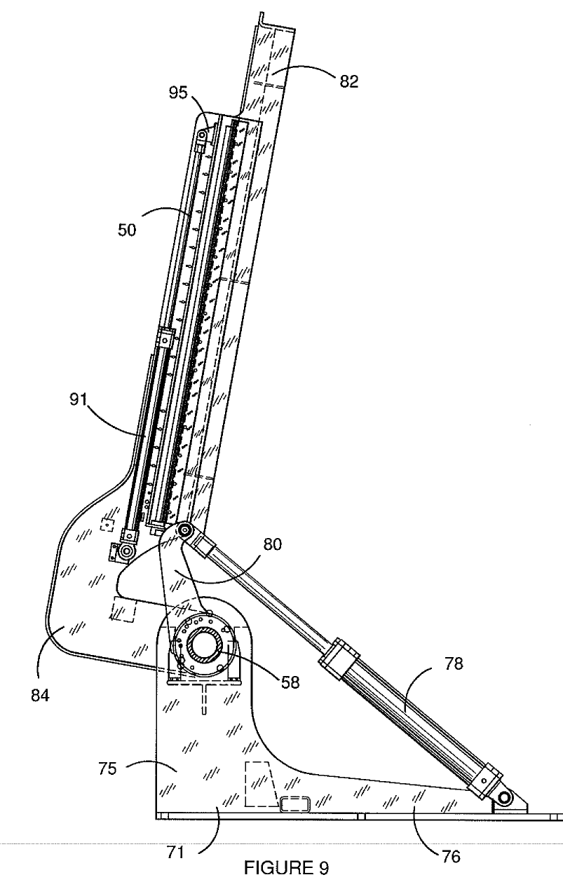

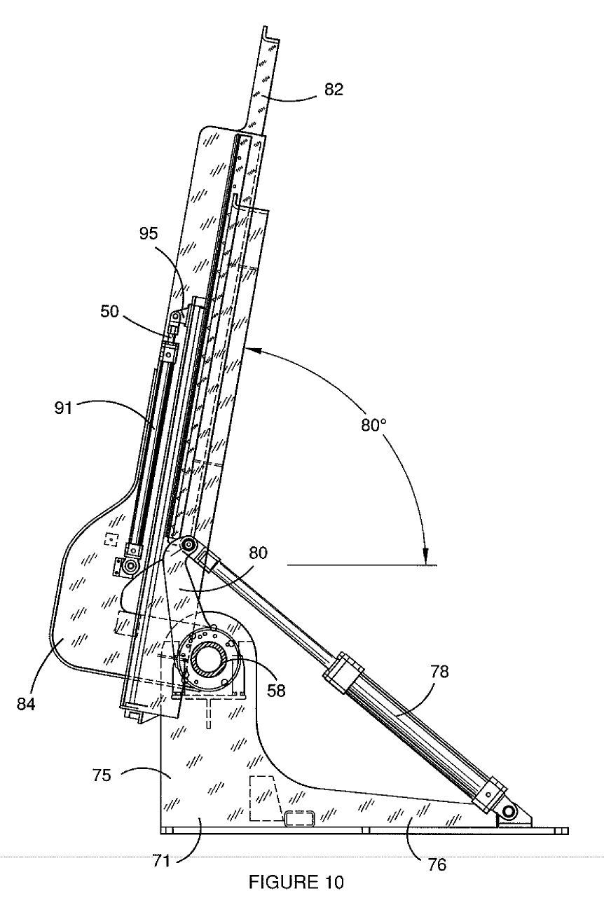

The embodiment that is shown in FIGS. 6 to 10 is capable of carrying loads of 500 kg. In this embodiment, the cutting table 50 is not only driven from an operative horizontal position to an inclined position in the same manner as the previous embodiments, but the table can be displaced longitudinally to move the comparatively heavy work piece from a loading and unloading position shown in FIG. 10 to a cutting position shown in FIG. 9. In this embodiment, the cutting table 50 is much sturdier than the table of the previous two embodiments and comprises a rectangular frame 51 that supports a plurality of equally spaced beams 52 that can extend across the shorter sides of the tank 20 together with a plurality of cross members 53 and two pairs of diagonal bracing struts 54, 55. In this embodiment the cutting table 50 is not attached to the water tank 20 but is supported by a pair of pedestals 70, 71 that are bolted to the floor. A substantial hollow steel bar 58 extends across the pedestals 70, 71 along the length of the tank and is supported about the pedestals on flange bearings 73, 74 at either end so that the bar is axially rotatable. As shown in the side views, FIGS. 8 to 10, each pedestal 70, 71 comprises an upstanding column 75 that supports one end of the bar 58 and an elongate base structure 76 that is bolted to the floor and attached to one end of a hydraulic cylinder 78, 79. Each hydraulic cylinder 78, 79 is attached to a link 80 which is in turn coupled to the bar 58 so that expansion of the cylinder 78, 79 to the position shown in FIGS. 9 and 10 causes the bar 58 to rotate to in turn displace the cutting table 50 to the upwardly inclined position shown in FIGS. 9 and 10 and as the cylinders are contracted to the position shown in FIG. 8, the bar 58 is turned so that the cutting table 50 assumes the horizontal configuration. The degree of angular movement between the two positions is 80°.

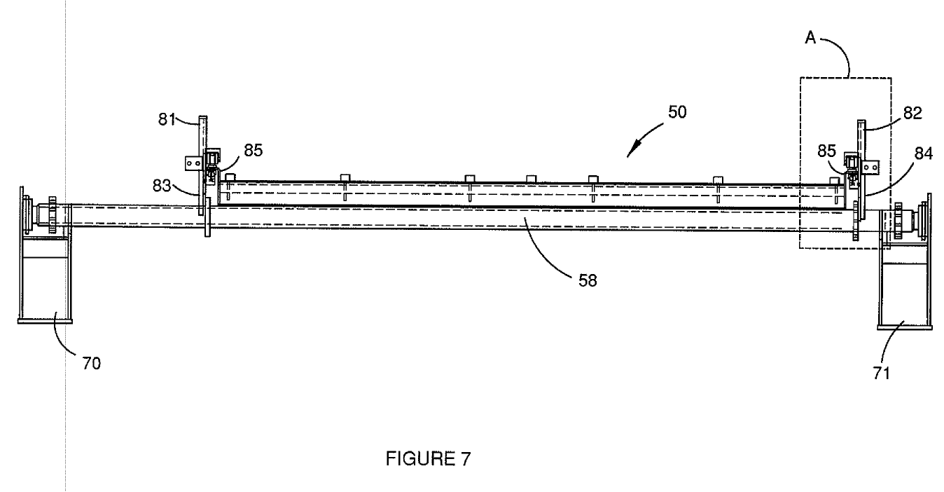

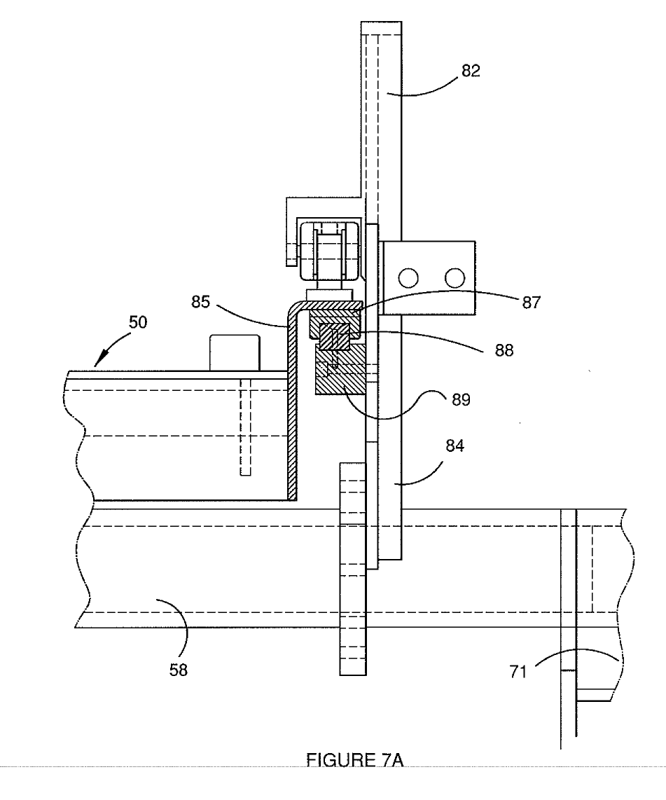

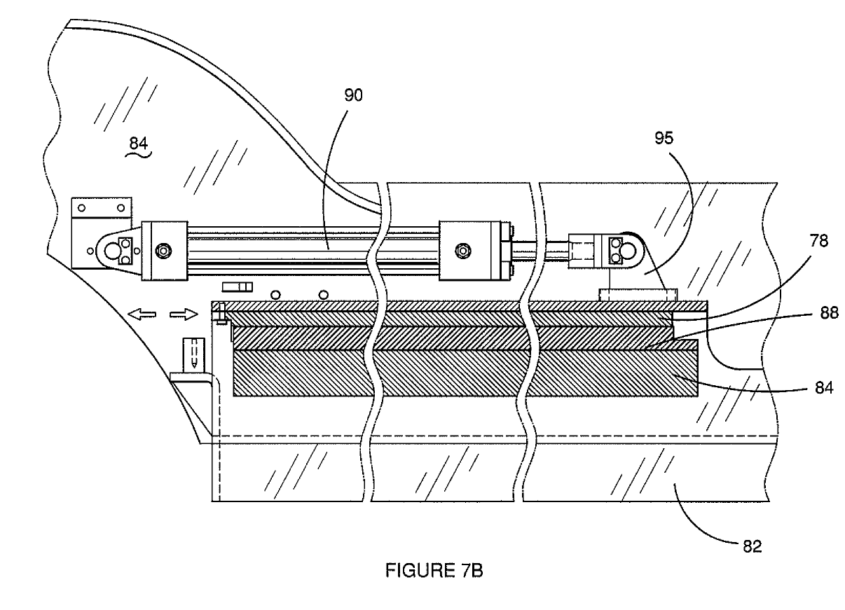

The table 50 itself is supported on either side by two side plates 81, 82 that are in turn coupled to the bar 58 via robust C shaped link arms 83, 84 that in effect mean that the table 50 is cantilevered to the bar 58 via the link arms 83, 84. As shown in FIGS. 7A and 7B each side of the table 50 has an angled flange 85, 86 that supports an elongate acetal wear block 87 that rests in parallel with a lower acetal wear block 88 that is in turn supported by a stainless steel block 89 that runs parallel to the side arm 82. In this manner the table 50 can slide on the acetal blocks 87, 88 longitudinally of arms 81, 82. As shown in FIG. 7B, a hydraulic ram 90, 91 connected at one end to the C shaped link arm 83, or 84 is coupled to a clevis 95 extending from the top of the angled flange 85, 86 of the table 50. Thus, the table 50 can be displaced by the rams 90, 91 to move from a lowered position shown in FIG. 10 to an elevated position shown in FIG. 9.

Thus, in use, a delicate but heavy work piece is first carefully positioned on the apparatus with the cutting table 50 in the inclined and lowered position shown in FIG. 10. The table 50 is then displaced by the hydraulic cylinders 90, 91 to the upper position shown in FIG. 9 where the work piece in the operative position. The table 50 is then lowered using the rams 78, 79 to extend across the tank in the horizontal cutting position.

This mechanism substantially improves safety and ease of handling of very large and fragile work pieces.

In the embodiments described above hydraulic or pneumatic rams have been used to displace the cutting table. It is however understood that other drive means are envisaged such as linear displacement electric motors, linear actuators, servo motors or electrically driven worm and wheel drivers.

Having now described my invention what I claim is:

1. A work piece support structure for waterjet cutting apparatus comprising a cutting table having a plurality of spaced apart slats supported in a cantilever fashion by a bar arranged to be positioned at the top of the front of a water tank of the waterjet cutting apparatus and drive means to cause axial rotation of the bar from a first position in which the slats extend across the top of the tank to support a work piece for cutting and a second inclined position in which the slats extend upwardly to support the work piece during loading or unloading of the work piece.

2. The work piece support structure according to claim 1, wherein the slats are supported on the bar to be displaceable along the bar to vary the spacing of the slats.

3. The work piece support structure according to claim 1, wherein the bar is mounted on spaced apart bearings secured to the front of the tank.

4. The work piece support structure according to claim 1, wherein the drive means is a hydraulic or pneumatic ram.

5. The work piece support structure according to claim 1, wherein the spaced slats of the table comprise part of an open framework supported by side arms that are connected to the bar.

6. The work piece support structure according to claim 5, wherein the table is secured to the side arms to be displaceable longitudinally of the arms.

7. The work piece support structure according to claim 6 comprising second drive means to displace the table from a lowered position in which the work piece can be lifted onto or off the table to an operative position where the work piece is over the tank to facilitate the cutting operation.

8. The work piece support structure according to claim 7, wherein the second drive means is at least one hydraulic or pneumatic ram.

9. The work piece support structure according to claim 6, wherein each side of the table is adapted to slide relative to each side arm, low friction blocks being positioned between the sliding surfaces of the sides of the table and the side arms.

10. The work piece support structure according to claim 1, wherein the bar is supported at either end by free standing pedestals.

11. The work piece support structure according to claim 10, wherein the drive means is positioned in each pedestal and adapted to rotate the bar through about 80°.
